(19) United States
(12) Patent Application Publication
(10) Pub. No.: US 2020/0074769 A1
(43) Pub. Date: Mar. 5, 2020

(54) Vehicle Fault Handling Method, Apparatus, Device and Storage Medium

(71) Applicant: Baidu Online Network Technology (Beijing) Co., Ltd., Haidian District Beijing (CN)

(72) Inventors: Kai Yang, Haidian District Beijing (CN); Lei Zhang, Haidian District Beijing (CN); Hongda Zhang, Haidian District Beijing (CN); Qijuan Yin, Haidian District Beijing (CN); Wuzhao Zhang, Haidian District Beijing (CN); Baisheng Wang, Haidian District Beijing (CN)

(73) Assignee: Baidu Online Network Technology (Beijing) Co., Ltd., Haidian District Beijing (CN)

(21) Appl. No.: 16/515,644

(22) Filed: Jul. 18, 2019

(30) Foreign Application Priority Data
Aug. 30, 2018 (CN) 201811002879.8

(51) Int. Cl. G07C 5/08; B60T 7/12; B60Q 5/00; B60Q 9/00; B60T 8/17

(52) U.S. Cl. CPC G07C 5/0808; G07C 5/085; G07C 5/0833; G07C 5/0825; B60T 2250/00; B60Q 5/005; B60Q 9/00; B60T 8/17; B60T 7/12

(57) ABSTRACT

The present application provides a vehicle fault handling method, an apparatus, a device, and a storage medium, where the method includes: a vehicle fault handling device obtains data information of a main system of the vehicle in real time; the vehicle fault handling device determines whether the main system has a fault according to the data information; and the vehicle failure processing device controls travelling status of the vehicle if the main system has a fault. Safety hazards of the vehicle that are caused by the fault in the main system can be avoided and the safety of the driverless vehicle can be enhanced effectively.

### CROSS-REFERENCE TO RELATED APPLICATIONS

This application claims priority to Chinese Patent Application No. 201811002879.8, filed on Aug. 30, 2018, which is hereby incorporated by reference in its entirety.

### TECHNICAL FIELD

The present application relates to the field of driverless technology, and in particular, to a vehicle fault handling method, a vehicle fault handling apparatus, a vehicle fault handling device, and a storage medium.

### BACKGROUND

A driverless vehicle is a new type of smart vehicle. It mainly uses an electronic control unit (ECU) to perform accurate controlling, calculating and analyzing on various parts of the vehicle to realize a fully automatic operation of the vehicle, thereby achieving the purpose of driverless driving.

For a driverless driving system, when a driverless vehicle fails to transfer data timely due to a system's software and/or hardware failure during travelling, if the vehicle is still running, unpredictable safety hazards may occur.

### SUMMARY

A vehicle fault handling method, a vehicle fault handling apparatus, a vehicle fault handling device and a storage medium are provided in the present application to address defects, such as low safety, in conventional vehicles.

In a first aspect of the present application, a vehicle fault handling method is provided, which includes:

obtaining, by a vehicle fault handling device, data information of a main system of a vehicle in real time;

determining, by the vehicle fault handling device, whether the main system has a fault according to the data information; and

controlling, by the vehicle fault handling device, travelling status of the vehicle if the main system has a fault.

In a second aspect of the present application, a vehicle fault handling apparatus is provided, which includes:

an obtaining module, configured to obtain, by a vehicle fault handling device, data information of a main system of a vehicle in real time;

a determining module, configured to determine, by the vehicle fault handling device, whether the main system has a fault according to the data information; and

a processing module, configured to control, by the vehicle fault handling device, travelling status of the vehicle if the main system has a fault.

In a third aspect of the present application, a vehicle fault handling device is provided, which includes: at least one processor and a memory;

the memory has a computer program stored therein; and the at least one processor is configured to execute the computer program stored in the memory to perform the method according to the first aspect.

In a fourth aspect of the present application, a computer readable storage medium is provided, where the computer readable storage medium has a computer program stored therein, and the computer program, when being executed, implements the method according to the first aspect.

According to the vehicle fault handling method, apparatus, device and storage medium provided by the application, a vehicle default handling device is set on an industrial personal computer of the vehicle to monitor a main system of the industrial personal computer, related data information of the main system is obtained in real time, whether the main system has a fault is determined according to the related data information, and the vehicle fault handling device controls the travelling status of the vehicle when the main system has a fault, thereby avoiding safety hazards of the vehicle that are caused by the fault in the main system and enhancing the safety of the driverless vehicle effectively.

### BRIEF DESCRIPTION OF DRAWINGS

In order to illustrate the technical solutions of embodiments of the present application, or the technical solution of the prior art, the drawings used in the embodiments of the present application or the prior art will be briefly described below. It is apparent that the drawings in the following description are only some embodiments of the present application; other drawings may be obtained by those of ordinary skill in the art without any creative efforts.

FIG. 1 is a schematic flowchart of a vehicle fault handling method according to an embodiment of the present application;

FIG. 2 is a schematic flowchart of a vehicle fault handling method according to another embodiment of the present application;

FIG. 3 is a schematic structural diagram of a vehicle fault handling apparatus according to an embodiment of the present disclosure; and

FIG. 4 is a schematic structural diagram of a vehicle fault handling device according to an embodiment of the present application.

Specific embodiments of the present application are illustrated by the above-described figures, which will be described in detail hereinafter. The drawings and the text are not intended to limit the scope of the present disclosure in any way, but to illustrate the concept of the present application with reference to the specific embodiments for those of ordinary skill in the art.

### DESCRIPTION OF EMBODIMENTS

The technical solutions of embodiments of the present application are clearly and thoroughly described in the following with reference to the accompanying drawings of the embodiments of the present application. It is apparent that the embodiments described herein are merely a part of, rather than all of, the embodiments of the present application. All other embodiments obtained by those of ordinary skill in the art based on the embodiments of the present application without creative efforts shall fall within the scope of the present application.

First, terms that are involved in the present application are explained as follow.

Industrial personal computer: IPC for short, is an industrial control computer. It is a general term for tools that use a bus structure to detect and control production processes, electromechanical equipment and process equipment. The industrial personal computer has significant computer properties and features, such as having a computer motherboard, a CPU, a hard disk, a memory, a peripheral and an interface, and has an operating system, control network and protocol, capability of computing, and a friendly human-machine interface. The products and technologies in the industry control domain are very special and belong to intermediate products, which provide stable, reliable, embedded and intelligent industrial computers for other industries. In a driverless vehicle, the industrial personal computer is a tool for detecting and controlling various aspects of the vehicle, which can be called an in-vehicle terminal.

Main system: it refers to a main system of an industrial personal computer of a driverless vehicle, which is responsible for collecting data perceived by the vehicle, and planning and controlling the vehicle, so as to achieve automatic driving.

A vehicle fault handling method provided by an embodiment of the present application is applicable to the following driverless driving system, where the driverless driving system includes an industrial personal computer which has a functional safety subsystem (i.e., vehicle fault handling device), and may also include a main system, that is, the functional safety subsystem may be built on the same hardware (industrial personal computer) as the main system, to monitor the main system of the industrial personal computer, so as to realize the finding of vehicle faults as well as recalling. In other similar driverless functional systems, the vehicle fault handling method provided by the embodiment of the present application may also be adopted. The vehicle fault handling method provided by the embodiment of the present application is not limited to the use in a driverless driving system.

Moreover, the terms “first”, “second”, and the like are used for the purpose of description only, but are not to be construed as indicating or implying a relative importance or implicitly indicating the number of technical features indicated. In the following description of the respective embodiments, the meaning of “a plurality” is two or more unless specifically defined otherwise.

The following specific embodiments may be combined with each other. The same or similar concepts or processes may not be repeated in some embodiments. Embodiments of the present application will be described below with reference to the accompanying drawings.

### Embodiment 1

The embodiment provides a vehicle fault handling method for performing fault handling on a driverless vehicle. The execution subject of the embodiment is a vehicle fault handling device, which can be set on an industrial personal computer of the vehicle.

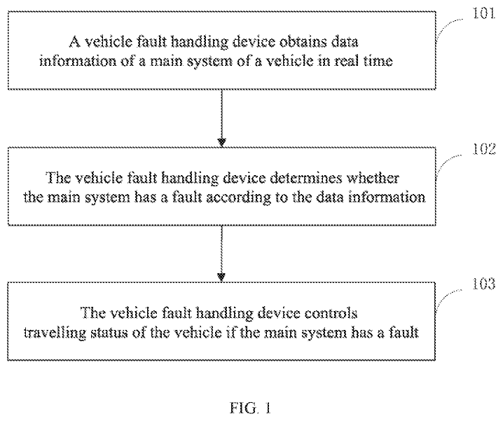

FIG. 1 is a schematic flowchart of a vehicle fault handling method provided by the embodiment, where the method includes:

Step 101: A vehicle fault handling device obtains data information of a main system of a vehicle in real time.

Step 102: The vehicle fault handling device determines whether the main system has a fault according to the data information.

Step 103: The vehicle fault handling device controls travelling status of the vehicle if the main system has a fault.

Specifically, the vehicle fault handling device is built on the industrial personal computer where the main system of the driverless vehicle is located, so that the state of the main system is monitored in real time, and the finding of the fault and recalling can be performed timely.

The data information of the main system of the vehicle can be obtained by the vehicle fault handling device in real time. The data information here may be data related to any layer or link in the main system. For example, the main system may be divided into three layers: perception, planning and control. Perception refers to the ability of a driverless system to gather information from the environment and extract relevant knowledge from the information. Environmental perception specifically refers to the capability of understanding a scene of the surroundings and semantic classification of data, such as detection of obstacle location and road signs/markers, detection of pedestrians and vehicles, etc. In general, localization is also part of perception, where localization is a capability of a driverless vehicle to determine its position relative to the surroundings. Planning is a process by which a driverless vehicle makes some purposeful decisions for a certain goal. For a driverless vehicle, such goal usually refers to reaching a destination from a place of departure while avoiding obstacles, and continuously optimizing the driving trajectory and behaviors to ensure the safety and comfort of passengers. The layer of planning is usually subdivided into three layers: mission planning, behavioral planning, and motion planning. Control is a capability of a driverless vehicle to accurately perform planned behaviors from higher layers. Each layer may involve transmission of various data, and a normal and accurate transmission of the data is an important basis for an autonomous vehicle to be able to fully auto-drive. The vehicle fault handling device can obtain data information of these data in real time, where the data information may include the data itself and other related information regarding the transmission of the data, such as frequency information and delay information, which can be set according to actual needs and is not limited in this embodiment. The vehicle fault handling device may obtain one or more types of data information of the main system according to actual needs, as long as the information can be used for determining a vehicle fault. For example, it may include one or more of frequency information, delay information, heartbeat detection information, collision detection information, information collected from a chassis, information on an automatic driving assistance process, security gateway monitoring information and information on industrial personal computer environment.

Manners for obtaining the data information of the main system by the vehicle fault handling device may be that the data flows in the main system send related data to the vehicle fault handling device actively when being executed, or that the vehicle fault handling device requests data information from the main system in real time. The specific manner is not limited herein. In short, the vehicle fault handling device can obtain various data information of the main system.

Exemplarily, the vehicle fault handling device may obtain the above data information from an in-vehicle ECU, the in-vehicle ECU may collect signals of sensors on the vehicle, and generate a control signal according to the collected signals. The vehicle fault handling device may be connected to the ECU by wires or wirelessly, send a data acquisition request to the ECU, and receive data information sent by the ECU.

Exemplarily, the vehicle fault handling device may also be communicatively connected with the sensors on the vehicle directly. The data information of the main system may be obtained by obtaining information detected by a sensor that is associated with a data flow of the main system, for example, a sensor associated with collision detection, a sensor associated with chassis collection, a sensor associated with security gateway monitoring, a sensor associated with industrial personal computer environment or the like. The sensor may include an image sensor, a mechanical sensor, a speed sensor, an acceleration sensor, a temperature sensor, a distance sensor, and the like.

After obtaining the data information of the main system, the vehicle fault handling device determines whether the main system has a fault according to the data information. If the main system has a fault, the vehicle fault handling device controls the travelling status of the vehicle, for example, to control the vehicle to stop, decelerate or drive along roadside, or pull over and so on.

It should be noted that the vehicle fault handling device is given a permission to control the vehicle when being built, which can be set in a configuration file in advance.

Optionally, for the obtained various data information, preset conditions corresponding to various data information may be pre-configured, such as a preconfigured reference range. If the data information does not satisfy the corresponding preset condition, the main system may be considered as having a fault.

Optionally, fault types corresponding to different data information may also be pre-configured, and different handling measures are set for different fault types, e.g. determining whether to stop, decelerate, or turn. It may be set according to actual needs.

According to the vehicle fault handling method provided by the embodiment, a vehicle fault handling device is set in an industrial personal computer of a vehicle to monitor a main system of the industrial personal computer in real time, related data information of the main system is obtained in real time, whether the main system has a fault is determined according to the related data information, and the vehicle fault handling device controls the travelling status of the vehicle when the main system has a fault, thereby avoiding safety hazards of the vehicle that are caused by the fault in the main system and enhancing the safety of the driverless vehicle effectively.

### Embodiment 2

This embodiment gives further illustrations of the method provided in Embodiment 1.

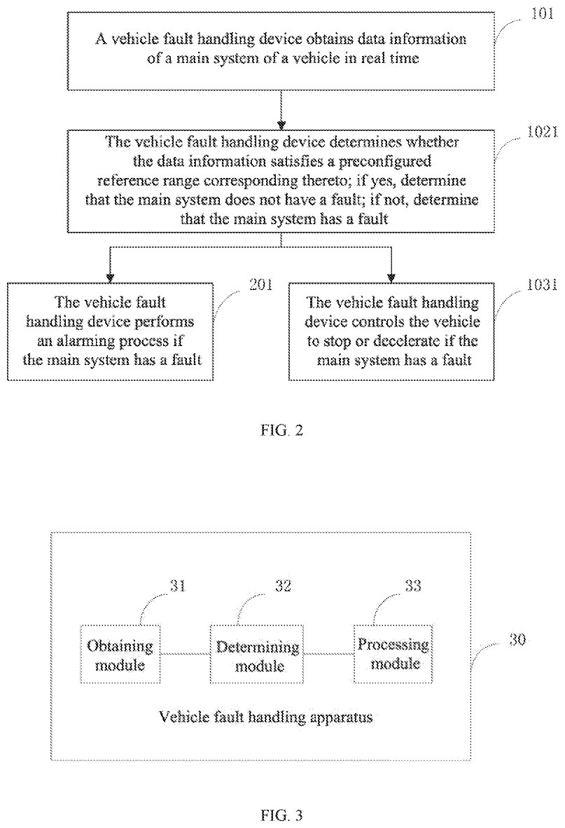

FIG. 2 is a schematic flowchart diagram of a vehicle fault handling method provided by the present embodiment.

As an implementation manner, on the basis of the foregoing Embodiment 1, alternatively, the data information includes one or more of frequency information, delay information, heartbeat detection information, collision detection information, information collected from chassis (for example, steering angle information), information on an automatic driving assistance process (for example, human-machine interface (HMI)), security gateway monitoring information and information on industrial personal computer environment, CPU usage rate, ECP fault code, memory usage, disk information and the like.

Specifically, the frequency information may refer to a transmission frequency of data flow in the main system, the delay information may refer to delay information of transmission of data flow in the main system, heartbeat detection information may be, for example, detecting whether a process is online, and the collision detection information may be detection information about whether there is an obstacle around the vehicle which is likely to cause a collision, etc. The information collected from the chassis includes steering angle, braking, vehicle control, etc. The types of data information that the vehicle fault handling device can obtain are far more than these types. Many other types can be included according to actual needs, as long as it is main system-related data. The content of the specific data information may be set according to actual needs, which is not limited herein.

As another implementation manner, on the basis of the foregoing Embodiment 1, optionally, step 102 specifically includes:

Step 1021: The vehicle fault handling device determines whether the data information satisfies a preconfigured reference range corresponding there the data information; if yes, it is determined that the main system does not have a fault; if not, it is determined that the main system has a fault.

Specifically, preconfigured reference ranges corresponding to various types of data information may be preset. After the data information is obtained, each type of data information is compared with a preconfigured reference range corresponding to the data information. If each type of data information satisfies the preconfigured reference range corresponding to the data information, it is determined that the main system does not have a fault. If any one or more of the types of data information does not satisfy the preconfigured reference range corresponding to the data information, it is determined that the main system has a fault.

Specifically, step 1021 can include:

The vehicle fault handling device compares the data information with a maximum value and a minimum value of the preconfigured reference range corresponding to the data information; if the data information is greater than the maximum value of the preconfigured reference range or less than the minimum value of the preconfigured reference range, it is determined that the data information does not satisfy the preconfigured reference range corresponding to the data information; and if the data information is smaller than the maximum value of the preconfigured reference range and greater than the minimum value of the preconfigured reference range, it is determined that the data information satisfies the preconfigured reference range corresponding to the data information. Here, the preconfigured reference range may be a threshold. For example, if the obtained data information is greater than the threshold, the condition is satisfied; if smaller than the threshold, the condition is not satisfied. The specific form is not limited herein.

Exemplarily, a preconfigured reference range corresponding to the frequency information is 10-15 HZ, and the frequency information obtained is 5 HZ. The frequency information obtained is not within the preconfigured reference range, and thus the main system can be considered as having a fault. For example, if the preconfigured reference range corresponding to the delay information is less than 400 ms (milliseconds) and the delay information obtained is 800 ms, the main system may be considered as having a fault.

In yet another implementation manner, based on the foregoing Embodiment 1, optionally, step 103 specifically includes:

Step 1031: The vehicle fault handling device controls the vehicle to stop or decelerate if the main system has a fault.

Specifically, if it is determined that the main system has a fault, data flows of the main system cannot be delivered normally, which may easily cause a problem that the control layer of the vehicle cannot receive a corresponding instruction from a higher layer, thereby the vehicle continues to travel, resulting in a serious safety hazard. Therefore, the vehicle fault handling device may control the vehicle to decelerate or stop timely, and may also control the vehicle to pull over, park, etc. The specific control strategy can be set according to fault situations.

Further, the step 1031 may specifically include: the vehicle fault handling device sends a brake instruction to a brake system of the vehicle, so that the brake system performs a braking and decelerating process, or a stopping process according to the brake instruction.

Specifically, it may be set in a configuration file in advance to give the vehicle fault handling device a permission to control the vehicle, so that when the main system is determined to have a fault, a brake instruction can be sent to the brake system timely to decelerate or stop the vehicle in time.

Optionally, the vehicle fault handling device may further determine the travelling direction of the vehicle according to the obtained data information, and take into account the collision detection information, the information collected by chassis, etc., to analyze and decide whether the vehicle needs a change in direction, and if it needs a change in direction, control the vehicle to change the direction, or control the vehicle to pull over during pulling up.

In yet another implementation manner, on the basis of the foregoing Embodiment 1, optionally, if the main system has a fault, the method may further include:

Step 201: The vehicle fault handling device performs an alarming process.

Optionally, the step 201 may include: the vehicle fault handling device generates an alarming tone for warning.

Optionally, step 201 may specifically include: the vehicle fault handling device generates an alarming message to display on a screen of the vehicle.

Optionally, the step 201 may include: the vehicle fault handling device generates alarming information to send to a remote control server.

Specifically, after the vehicle fault handling device determines that the main system has a fault, it may control the travelling status of the vehicle on the one hand, and may also warn relevant personnel, such as passengers, management personnel, vehicle maintenance personnel, and the like on the other hand.

Specific alarming manners may be an audible alarm, an alarm displayed on the screen of the vehicle, or an alarm sent to the remote control server of the vehicle. The specific manner is not limited herein.

Exemplarily, an alarming tone is made to warn the passengers in the vehicle to perform a corresponding security processing, or to warn other vehicles to give way, or to warn test management personnel outside the vehicle of maintenance and the like.

Optionally, while the vehicle fault handling device monitoring the main system, the main system may also monitor the vehicle fault handling device, such as monitoring by heartbeat detection. If the vehicle fault handling device has a fault, the main system may also control the travelling status of the vehicle, such as deceleration, braking, changing direction, etc.

It should be noted that the implementation manners in this embodiment may be implemented separately, or may be implemented in any combination in the case of no conflict.

According to the vehicle fault handling method provided by the embodiment, a vehicle fault handling device is set on an industrial personal computer of a vehicle to monitor a main system on the industrial personal computer in real time, related data information of the main system is obtained in real time, whether the main system has a fault is determined according to the related data information, and the vehicle fault handling device controls the travelling status of the vehicle when the main system has a fault, thereby avoiding safety hazards of the vehicle that are caused by the fault in the main system and enhancing the safety of the driverless vehicle effectively. Moreover, an alarm can be issued to promptly alert relevant personnel of taking corresponding safety measures, thereby further improving the safety of the vehicle.

### Embodiment 3

The present embodiment provides a vehicle fault handling apparatus for performing the method according to Embodiment 1.

FIG. 3 is a schematic structural diagram of a vehicle fault handling apparatus provided in this embodiment. The vehicle fault handling apparatus 30 includes an obtaining module 31, a determining module 32, and a processing module 33.

The obtaining module 31 is configured to obtain, by a vehicle fault handling device, data information of a main system of a vehicle in real time; the determining module 32 is configured to determine, by the vehicle fault handling device, whether the main system has a fault according to the data information; and the processing module 33 is configured to control, by the vehicle fault handling device, travelling status of the vehicle if the main system has a fault.

With regard to the apparatus in this embodiment, the specific manner in which the respective modules perform operations has been described in detail in the method embodiment, which will not be repeated herein.

According to the vehicle fault handling apparatus provided by the embodiment, a vehicle fault handling device is set on an industrial personal computer of a vehicle to monitor the main system of the industrial personal computer in real time, related data information of the main system is obtained in real time, whether the main system has a fault is determined according to the related data information, and the vehicle fault handling device controls the travelling status of the vehicle when the main system has a fault, thereby avoiding safety hazards of the vehicle that are caused by the fault in the main system and enhancing the safety of the driverless vehicle effectively.

### Embodiment 4

The present embodiment gives further illustrations of the apparatus provided in the Embodiment 3.

As an implementation manner, on the basis of the foregoing Embodiment 3, optionally, the data information includes one or more of frequency information, delay information, heartbeat detection information, collision detection information, information collected from chassis, information on an automatic driving assistance process, security gateway monitoring information and information on industrial personal computer environment.

As another implementation manner, on the basis of the foregoing Embodiment 3, optionally, the determining module is specifically configured to:

determine, by the vehicle fault handling device, whether the data information satisfies a preconfigured reference range corresponding to the data information; if yes, determine that the main system does not have a fault; if not, determine that the main system has a fault.

Optionally, the determining module is specifically configured to:

compare, by the vehicle fault handling device, the data information with a maximum value and a minimum value of the preconfigured reference range corresponding to the data information; if the data information is greater than a maximum value of the preconfigured reference range or less than a minimum value of the preconfigured reference range, determine that the data information does not satisfy the preconfigured reference range corresponding to the data information; and if the data information is smaller than the maximum value of the preconfigured reference range and greater than the minimum value of the preconfigured reference range, determine that the data information satisfies the preconfigured reference range corresponding to the data information.

In yet another implementation manner, on the basis of the foregoing Embodiment 3, optionally, the processing module is specifically configured to:

control, by the vehicle fault handling device, the vehicle to stop or decelerate if the main system has a fault.

Optionally, the processing module is specifically configured to:

send, by the vehicle fault handling device, a brake instruction to a brake system of the vehicle, so that the brake system performs a braking and decelerating process, or a stopping process according to the brake instruction.

In yet another implementation manner, on the basis of the foregoing Embodiment 3, optionally, if the main system has a fault, the processing module is further configured to perform, by the vehicle fault handling device, an alarming process.

Optionally, the processing module is specifically configured to:

generate, by the vehicle fault handling device, an alarming tone for warning.

Optionally, the processing module is specifically configured to:

generate, by the vehicle fault handling device, an alarming message for displaying on a screen of the vehicle.

Optionally, the processing module is specifically configured to:

generate, by the vehicle fault handling device, alarming information to send to a remote control server.

With regard to the apparatus in this embodiment, the specific manner in which the respective modules perform operations has been described in detail in the method embodiment, and therefore not repeated herein.

It should be noted that the implementation manners in this embodiment may be implemented separately, or may be implemented in any combination in the case of no conflict.

According to the vehicle fault handling apparatus provided by the embodiment, a vehicle fault handling device is set on an industrial personal computer of a vehicle to monitor a main system on the industrial personal computer in real time, related data information of the main system is obtained in real time, whether the main system has a fault is determined according to the related data information, and the vehicle fault handling device controls the travelling status of the vehicle when the main system has a fault, avoiding safety hazards of the vehicle that are caused by the fault in the main system and enhancing the safety of the driverless vehicle effectively.

### Embodiment 5

The embodiment provides a vehicle fault handling device for performing the vehicle fault handling method provided by the above embodiments.

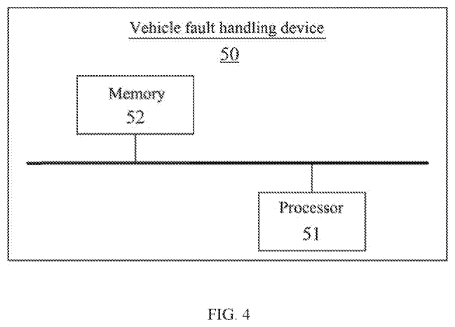

FIG. 4 is a schematic structural diagram of a vehicle fault handling device provided in this embodiment. The vehicle fault handling device 50 includes: at least one processor 51 and a memory 52.

The memory has a computer program stored therein. The at least one processor is configured to execute the computer program stored in the memory to perform the method according to the above embodiments.

Optionally, the vehicle fault handling device may be an industrial personal computer, and may be considered as a functional safety subsystem built on the industrial personal computer to monitor the state of the main system. It can be set specifically according to actual needs.

According to the vehicle fault handling device provided by the embodiment, a vehicle fault handling device is set on an industrial personal computer of a vehicle to monitor a main system on the industrial personal computer in real time, related data information of the main system is obtained in real time, whether the main system has a fault is determined according to the related data information, and the vehicle fault handling device controls the travelling status of the vehicle when the main system has a fault, thereby avoiding safety hazards of the vehicle that are caused by the fault in the main system and enhancing the safety of the driverless vehicle effectively.

### Embodiment 6

The present embodiment provides a computer readable storage medium, where the computer readable storage medium has a computer program stored therein, and the computer program when being executed, implements the method according to any embodiments mentioned above.

According to the computer readable storage medium provided by the embodiment, a vehicle fault handling device is set on an industrial personal computer of a vehicle to monitor a main system on the industrial personal computer in real time, related data information of the main system is obtained in real time, whether the main system has a fault is determined according to the related data information, and the vehicle fault handling device controls the travelling status of the vehicle when the main system has a fault, thereby avoiding safety hazards of the vehicle that are caused by the fault in the main system and enhancing the safety of the driverless vehicle effectively.

In the several embodiments provided by the present application, it should be understood that the disclosed apparatus and method may be implemented in other manners. For example, the apparatus embodiments described above are merely illustrative. For example, the division of units is only a division of logical functions. In actual implementation, there may be other division manners, for example, multiple units or components may be combined or integrated into another system, or some features can be ignored or not executed. In addition, the mutual coupling or direct coupling or communicative connection shown or discussed may be an indirect coupling or communicative connection via some interfaces, devices or units, and may be in an electrical, mechanical or other form.

The units described as separate components may or may not be physically separated, and the components displayed as units may or may not be physical units, that is, the) may be located in one site, or may be distributed across multiple network units. Some or all of the units may be selected according to actual needs to serve the purpose of the solution of the embodiments.

In addition, each functional unit in each embodiment of the present application may be integrated into a processing unit, or may be presented as each unit that are separated physically, or two or more units may be integrated into one unit. The above integrated units may be implemented in the form of hardware or in the form of hardware plus software functional units.

The above integrated units implemented in the form of software functional units may be stored in a computer readable storage medium. The software functional unit described above is stored in a storage medium and includes instructions for causing a computer device (which may be a personal computer, a server, or a network device, etc.) or a processor to perform part of the steps of the methods described in various embodiments of the present application. The foregoing storage medium includes medium that is capable of storing program codes, such as a USB flash disc, a mobile hard disk, a read-only memory (ROM), a random access memory (RAM), a magnetic disk, or a compact disk, and the like.

Those of ordinary skill in the art should understand that for the purpose of convenience and brevity, the division of each functional module described above is illustrative. In practical applications, the above functions may be assigned to different functional modules for implementation as needed, that is, the internal structure of the apparatus is divided into different functional modules to perform all or part of the functions described above. For the specific working process of the apparatus described above, reference may be made to the corresponding process in the foregoing method embodiments, and details are not repeated herein.

At last, it should be noted that the above embodiments are merely illustrative of the technical solutions of the present application, and are not intended to be limiting. Although the present application has been described in detail with reference to the foregoing embodiments, those skilled in the art will understand that the technical solutions described in the foregoing embodiments may be modified, or that some or all of the technical features may be equivalently substituted; these modifications or substitutions do not deviate the nature of the corresponding technical solution from the scope of the technical solutions of various embodiments according to the present application.

What is claimed is:

1. A vehicle fault handling method, comprising:
obtaining, by a vehicle fault handling device, data information of a main system of a vehicle in real time;
determining, by the vehicle fault handling device, whether the main system has a fault according to the data information; and
controlling, by the vehicle fault handling device, travelling status of the vehicle if the main system has a fault.

2. The method according to claim 1, wherein the data information comprises one or more of frequency information, delay information, heartbeat detection information, collision detection information, information collected from a chassis, information on an automatic driving assistance process, security gateway monitoring information and information on industrial personal computer environment.

3. The method according to claim 1, wherein the determining, by the vehicle fault handling device, whether the main system has a fault according to the data information, comprises:
determining, by the vehicle fault handling device, whether the data information satisfies a preconfigured reference range corresponding to the data information;
if the data information satisfies the preconfigured reference range corresponding to the data information, determining that the main system does not have a fault;
if the data information does not satisfy the preconfigured reference range corresponding to the data information, determining that the main system has a fault.

4. The method according to claim 3, wherein the determining, by the vehicle fault handling device, whether the data information satisfies a preconfigured reference range corresponding to the data information, comprises:
comparing, by the vehicle fault handling device, the data information with a maximum value and a minimum value of the preconfigured reference range corresponding to the data information;
if the data information is greater than the maximum value of the preconfigured reference range or less than the minimum value of the preconfigured reference range, determining that the data information does not satisfy the preconfigured reference range corresponding to the data information; and
if the data information is smaller than the maximum value of the preconfigured reference range and greater than the minimum value of the preconfigured reference range, determining that the data information satisfies the preconfigured reference range corresponding to the data information.

5. The method according to claim 1, wherein controlling, by the vehicle fault handling device, travelling status of the vehicle if the main system has a fault, comprises:
controlling, by the vehicle fault handling device, the vehicle to stop or decelerate if the main system has a fault.

6. The method according to claim 5, wherein the controlling, by the vehicle fault handling device, the vehicle to stop or decelerate, comprises:
sending, by the vehicle fault handling device, a brake instruction to a brake system of the vehicle, so that the brake system performs a braking and decelerating process, or a stopping process according to the brake instruction.

7. The method according to claim 1, wherein if the main system has a fault, the method further comprises:
performing, by the vehicle fault handling device, an alarming process.

8. The method according to claim 7, wherein the performing, by the vehicle fault handling device, an alarming process, comprises:
generating, by the vehicle fault handling device, an alarming tone for warning.

9. The method according to claim 7, wherein the performing, by the vehicle fault handling device, an alarming process, comprises:
generating, by the vehicle fault handling device, an alarming message for displaying on a screen of the vehicle.

10. The method according to claim 7, wherein the performing, by the vehicle fault handling device, an alarming process, comprises:
generating, by the vehicle fault handling device, alarming information to send to a remote control server.

11. A vehicle fault handling apparatus, comprising at least one processor and a memory; wherein,
the memory has a computer program stored therein; and
the at least one processor, when executing the computer program, is configured to:
obtain data information of a main system of a vehicle in real time;
determine whether the main system has a fault according to the data information; and
control travelling status of the vehicle if the main system has a fault.

12. The apparatus according to claim 11, wherein the processor is configured to:
determine whether the data information satisfies a preconfigured reference range corresponding to the data information;
if the data information satisfies the preconfigured reference range corresponding to the data information, determine that the main system does not have a fault;
if the data information does not satisfy the preconfigured reference range corresponding to the data information, determine that the main system has a fault.

13. The apparatus according to claim 12, wherein the processor is configured to:
compare the data information with a maximum value and a minimum value of the preconfigured reference range corresponding to the data information;
if the data information is greater than the maximum value of the preconfigured reference range or less than the minimum value of the preconfigured reference range, determine that the data information does not satisfy the preconfigured reference range corresponding to the data information; and
if the data information is smaller than the maximum value of the preconfigured reference range and greater than the minimum value of the preconfigured reference range, determine that the data information satisfies the preconfigured reference range corresponding to the data information.

14. The apparatus according to claim 11, wherein the processor is configured to:
control the vehicle to stop or decelerate if the main system has a fault.

15. The apparatus according to claim 14, wherein the processor is configured to:
send a brake instruction to a brake system of the vehicle, so that the brake system performs a braking and decelerating process, or a stopping process according to the brake instruction.

16. The apparatus according to claim 11, wherein if the main system has a fault, the processor is further configured to perform an alarming process.

17. The apparatus according to claim 16, wherein the processor is configured to:
generate an alarming tone for warning.

18. The apparatus according to claim 16, wherein the processor is configured to:
generate an alarming message for displaying on a screen of the vehicle.

19. The apparatus according to claim 16, wherein the processor is configured to:
generate alarming information to send to a remote control server.

20. A non-volatile computer readable storage medium, wherein the non-volatile computer readable storage medium has a computer program stored therein, and the computer program, when being executed, implements a method including the steps of:
obtaining, by a vehicle fault handling device, data information of a main system of a vehicle in real time;
determining, by the vehicle fault handling device, whether the main system has a fault according to the data information; and
controlling, by the vehicle fault handling device, travelling status of the vehicle if the main system has a fault.
